(19) United States
(12) Patent Application Publication
(10) Pub. No.: US 2016/0308317 A1
(43) Pub. Date: Oct. 20, 2016

(54) CLIPABLE POWER EXTENSION CORD

(71) Applicant: Marc Julian Zech, Hamburg (DE)

(72) Inventor: Marc Julian Zech, Hamburg (DE)

(21) Appl. No.: 14/880,567

(22) Filed: Oct. 12, 2015

Related U.S. Application Data
(60) Provisional application No. 62/072,455, filed on Oct. 30, 2014.

(51) Int. Cl. H01R 25/00; H01R 25/16

(52) U.S. Cl. CPC H01R 25/003; H01R 25/161

(57) ABSTRACT

A power cord may include an upper housing including an electrical cord and one or more outlets, a lower clip, and an axle connecting the upper housing to the lower clip, the upper housing and lower clip being configured to rotate relative to one another about the axle.

### CROSS-REFERENCE TO RELATED APPLICATIONS

The present application claims priority to the earlier filed U.S. provisional application having Ser. No. 62/072,455, incorporated herein in its entirety.

### BACKGROUND OF THE INVENTION

Power strips have existed for many years. Usually they are meant to just lay on the floor and provide space to multiply the available outlets and extend the utility of a power cord. Since these power strips conventionally lay on the ground, they are often in the way of passerby. Conventional power strips are unpractical because users must bow down to use them, and furthermore these power strips are dangerous because a passerby might trip over them, or the power strip may be exposed to water on the floor, thereby risking electrocution. Additionally, to many people, conventional power strips are just an unpleasant sight.

### SUMMARY OF THE INVENTION

This invention is a bar-shaped power strip configured to clip onto external objects.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a power cord including an upper housing including an electrical cord and one or more electrical outlets, a lower clip, and an axle connecting the upper housing to the lower clip, the upper housing and lower clip being configured to rotate relative to one another about the axle.

The axle may include a spring configured to bias the upper housing and the lower clip to rotate towards one another.

At least one of the upper housing and the lower clip may include an angled portion to accommodate the motion of the upper housing and the lower clip as they rotate relative to one another about the axle.

The axle may be disposed within the upper housing. Ends of the axle may be fastened to the lower clip.

The one or more outlets may be disposed on a first side of the axle, and the upper housing may include a back portion disposed on a second side of the axle opposite the first side of the axle.

The upper housing and the lower clip may be in contact at one end thereof.

The upper housing and the lower clip may be in contact along a subset of their length.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is an overall view of a clippable power extension cord according to an exemplary embodiment of the present general inventive concept; and

FIG. 2 is an exploded view of the components of the exemplary embodiment of the present general inventive concept illustrated in FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that terms such as “upper” and “lower” as used herein are only used to distinguish one element from another, and are not intended to be limiting to the elements thus described Thus, an “upper” element could be a “lower” element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part “includes” or “comprises” an element, unless there is a particular description contrary thereto, the part can further include other elements, not excluding the other elements.

Hereinafter, one or more exemplary embodiments of the present general inventive concept will be described in detail with reference to accompanying drawings.

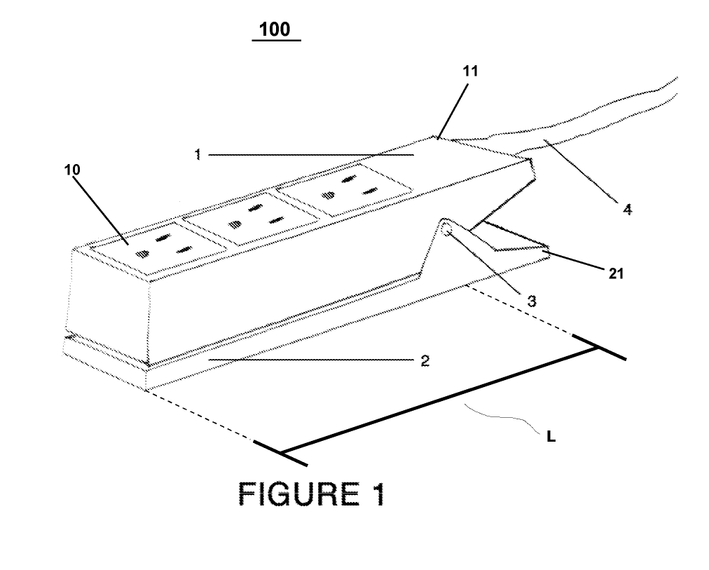

The clippable power extension cord 100 as illustrated in FIG. 1 includes three basic parts: An upper housing 1, an axle 3, and a lower clip 2. The upper housing 1 and the lower clip 2 are both mounted to the axle 3, allowing the upper housing 1 and the lower clip 2 to swivel around the axle 3.

The upper housing 1 which includes one or more outlets 10 and associated electronics—three outlets 10 are illustrated in FIG. 1, but the upper housing 1 may include more or fewer outlets 10 without departing from the present general inventive concept. The upper housing 1 may also include a power cord 4.

The lower clip 2 adds a clipping feature to the clippable power extension cord 100. The lower clip 2 and the upper housing 1 are connected to and revolve around the axle 3. The upper housing 1 and lower clip 2 may be mounted to the axle 3 at an angle, such that they are separate at back portions 11 and 21, and are in contact at an end opposite the back portions 11 and 21.

The axle 3 may include a spring 5 which biases the upper housing 1 and lower clip 2 portions towards a “closed” position in which the space between the upper housing 1 and lower clip 2 is minimized, as illustrated for example in FIG. 1. In the “closed” position, the upper housing 1 and lower clip 2 may be in contact at the end opposite the back portions 11 and 21. Alternatively, or in addition, as illustrated in FIG. 1 the upper housing 1 and lower clip 2 may be substantially parallel to one another in the “closed” position, such that they are in contact with each other along a length L, corresponding to a subset of their total lengths. This length L may extend from the axle 3 to the end opposite the back portions 11 and 21.

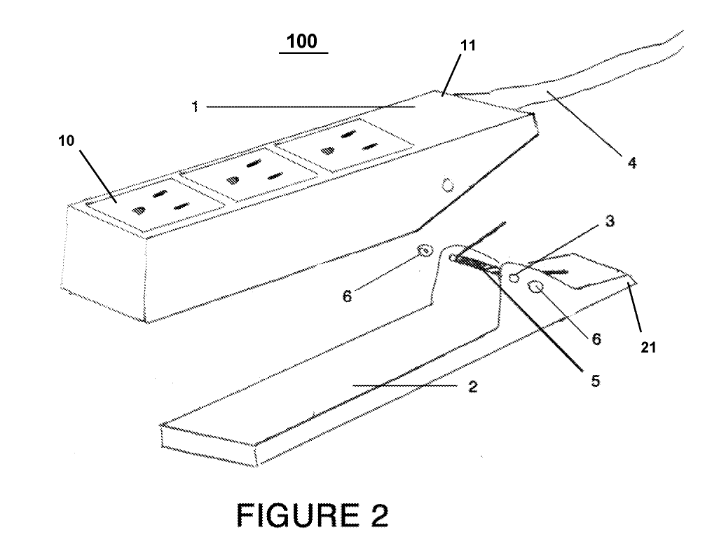

As illustrated for example in FIGS. 1 and 2, the axle 3 may be disposed within the upper housing 1, while the ends of the axle 3 may be fastened to the lower clip 2. The axle 3 may be secured by clips or bolts 6, to hold it in place with respect to the upper housing 1 and lower clip 2.

By rotating about the axle 3, the upper housing 1 and the lower clip 2 may be moved between the “closed” position of FIG. 1 and an “open” position, in which the upper housing 1 and lower clip 2 are rotated away from each other so that an external object may be inserted between them. The “open” position includes any configuration in which the upper housing 1 and lower clip 2 are rotated away from each other, and may include any number of rotational angles. When the upper housing 1 and lower clip 2 move to the “closed” position, they may clip around the external object inserted between them, thereby holding the clippable power extension cord 100 in place on the external object.

The spring 5 may be under tension and configured to build up more tension when the upper housing 1 and the lower clip 2 are moved to the “open” position, e.g., when back portion 11 back portion 21 are pushed together. This tension in the spring 5 may bias the upper housing 1 and lower clip 2 to be in the “closed” position, thereby enabling the whole clippable power extension cord 100 to grip and be affixed to external objects.

A user may squeeze the back portions 11 and 21 together to move the clippable power extension cord 100 from the “closed” position to the “open” position. One or both of the back portion 11 of the upper housing and the back portion 21 of the lower clip may be inclined to give space for the upper housing 1 and the lower clip 2 to rotate about the axle 3 and thereby move to the “open” position. Furthermore, in the exemplary embodiment of the present general inventive concept illustrated in FIGS. 1 and 2, the back portions 11 and 21 are on a side of the axle 3 opposite the outlets 10, and the back portions 11 and 21 do not include outlets 10. This configuration of the back portions 11 and 21 better enables a user to grip the back portions 11 and 21 without risk of electrocution, and also means that the force of pushing wires into the one or more outlets 10 pushes the upper housing 1 and lower clip together, as opposed to pushing them apart.

Furthermore, although the clippable power extension cord 100 is configured to be clipped to external objects and thereby held stationary, the clippable power extension cord 100 may also be used to hold external objects stationary. For example, various wires—such as for example wires plugged into the one or more outlets 10—may be clipped between the upper housing 1 and lower clip 2 and thereby held in place. Clipping wires in this manner can hold the wires in place and keep them from becoming tangled or tripping passerby.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A power cord, comprising:
an upper housing including an electrical cord and one or more electrical outlets;
a lower clip; and
an axle connecting the upper housing to the lower clip, the upper housing and lower clip being configured to rotate relative to one another about the axle.

2. The power cord of claim 1, wherein the axle comprises a spring configured to bias the upper housing and the lower clip to rotate towards one another.

3. The power cord of claim 1, wherein at least one of the upper housing and the lower clip comprises an angled portion to accommodate the motion of the upper housing and the lower clip as they rotate relative to one another about the axle.

4. The power cord of claim 1, wherein:
the axle is disposed within the upper housing; and
ends of the axle are fastened to the lower clip.

5. The power cord of claim 1, wherein the one or more outlets are disposed on a first side of the axle, and upper housing comprises a back portion disposed on a second side of the axle opposite the first side of the axle.

6. The power cord of claim 1, wherein the upper housing and the lower clip are in contact at one end thereof.

7. The power cord of claim 1, wherein the upper housing and the lower clip are in contact along a subset of their length.
